(19) United States
(12) Patent Application Publication
(10) Pub. No.: US 2015/0001819 A1
(43) Pub. Date: Jan. 1, 2015

(54) SNOW BODY BOARD

(71) Applicant: Mujezir Licina, Nesconset, NY (US)

(72) Inventor: Mujezir Licina, Nesconset, NY (US)

(21) Appl. No.: 14/321,775

(22) Filed: Jul. 1, 2014

Related U.S. Application Data
(60) Provisional application No. 61/841,686, filed on Jul. 1, 2013.

(51) Int. Cl. B62B 13/04; B62B 17/06

(52) U.S. Cl. CPC B62B 13/043; B62B 17/061
USPC 280/28.14

(57) ABSTRACT

The invention provides a snowboard designed to be ridden in a seated position. The top of the board is an oval or egg-shaped board having a blade attached to its underside by means of a riser. The blade is attached to the underside of the board lengthwise by means of a riser wherein the blade curves reflexively to be essentially parallel to the top surface of the board. The top of the board comprises cut out openings to be used as handles.

### CLAIM OF PRIORITY

This patent application claims priority under 35 USC 119 (e) (1) from U.S. Provisional Patent Application Serial Number 61/841,686 filed Jul. 1, 2013, of common inventorship herewith entitled, “Snow Body Board.”

### FIELD OF THE INVENTION

The present invention pertains to the field of snow sports, and more specifically to the field of snow recreational equipment.

### BACKGROUND OF THE INVENTION

The prior art has put forth several designs for snow recreational equipment. Among these are:

U.S. Pat. No. 7,537,221 to Philippe Lasala describes a snow sliding vehicle including a bearing rear runner and a directional front runner to which is connected a steering column pivoting in a sleeve firmly attached to the upper end of a stiff frame connecting both runners. The lower end is attached to a supporting base surmounting the bearing runner and provided for supporting the feet of the user. The front portion of said base is connected to the bearing runner by a mechanical connection providing it with clearance ostensibly perpendicular to said runner that is controlled by a damping device.

U.S. Pat. No. 6,969,076 to Ivan Malcolm Spiers describes a steerable snow scooter including a bilaterally pivotable independent forward portion, a hand operable direction controller, and an independent rearward portion in secured communication with the forward portion and having a support surface upon which to stand. The forward portion of the snow scooter is angularly adjustable for selecting approach pitch, while the rearward portion includes a brake member. A preferable direction controller is a stem with a handle bar set for grasping and turning by hand. The stem is in axially pivotally attached communication with the forward portion for selectively moving the stem between a generally vertical and a generally horizontal orientation to thereby permit folding the snow scooter for easy carrying and transport. The steerable snow scooter so defined permits the user thereof to easily ride and maneuver over a snow surface for an enjoyable experience.

US Patent 2003/068341 to David J. Fitzgerald, Terry J. Sanchez and Matthew R. Zilinskas describes a snow recreation device with a convex bottom surface that includes tracking and steering ridges. In some embodiments, the device includes raised handles configured to position a rider's grip above the bottom surface of the device.

None of these prior art references describe the present invention.

### SUMMARY OF THE INVENTION

It is an object of the present invention to provide a means of snowboarding in a seated position which is safer and easier for novice snowboarders.

### BRIEF DESCRIPTION OF THE DRAWINGS

FIG. 1 is a prototypical diagonal side view illustrating a seat, handles, riser and blade.

FIG. 2 is an illustrative top view showing oval or egg-shaped top of the present invention showing approximate dimensions.

FIG. 3 is a prototypical side view of the present invention.

FIG. 4 is a perspective bottom side view of the present invention showing approximate dimensions.

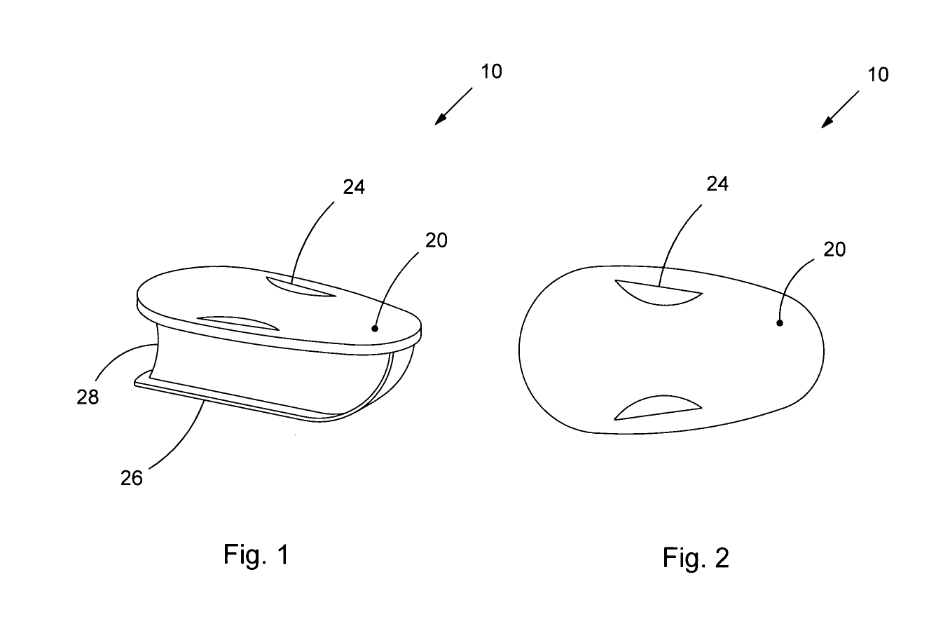

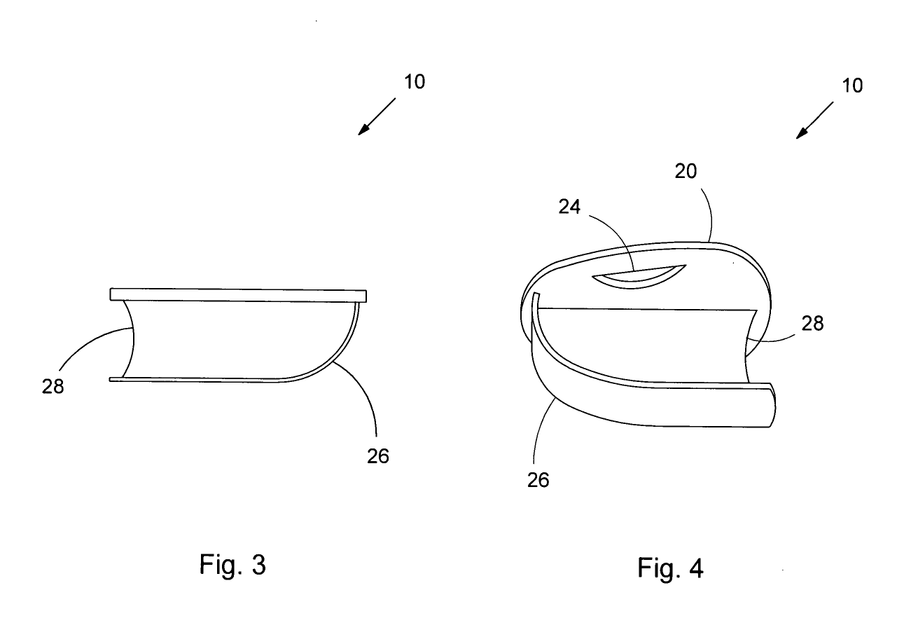

### DETAILED DESCRIPTION OF THE INVENTION

An extremely popular winter sport enjoyed by people from all walks of life is snowboarding. Snowboarding combines elements of surfing wild ocean waves with lightening fast movement of riding a skateboard along with exhilarating skill of downhill skiing. Once considered an extreme sport which appealed only to young rebels acid hippie free spirits, snowboarding slowly has garnered the respect of being a serious and complex sport. While snowboarding is both popular and fun, learning how to master the skills required to safely snowboard is challenging for many beginners. Maintaining an upright stance while hurling down a slick slope or flying airborne over a half pipe ditch ramp is extremely difficult for individuals who are just learning to ride. If one fails to maintain a proper stance when snowboarding, the result is an embarrassing and potentially dangerous wipeout. Many novices avoid the sport of snowboarding rather than risk injuring themselves on the slopes.

The present invention, hereinafter referred to as the Snow Body Board, is a snowboard that is ridden in a seated position and eliminates risks inherent with standing and riding. Snow Body Board enables novice snowboarders, particularly children and inexperienced adults, to enjoy the sport in a safe and comfortable manner. Comprised primarily of fiberglass or wooden material, the present invention is produced in a similar manner as traditional snowboards. However, unlike snowboards that usually are manufactured with three layers including a top sheet, core and base, the Snow Body Board comprises a solid one piece construction. Unlike traditional snowboards which are generally rectangular in shape, the Snow Body Board is wider and shorter with a unique oval or egg shape. The Snow Body Board is designed to be used in a seated position. The board 10 comprises a top 20 of the which is an oval or egg shape, with the narrow portion at the front of the board. The entire length of the board 10 is approximately nineteen inches. The rider is seated on the top of the oval and holds onto the board by means cut out openings 24 on each side of the device which function as handles. In an embodiment, the openings are elongated semi-circular in shape. The bottom of the board comprises a blade 26 which is attached to the bottom of the oval lengthwise. The blade 26 is attached to the bottom of the board by means of a riser 28. The length of the attachment of the riser is approximately sixteen inches. The blade 26 is configured similar to the runner of a sled. The blade 26 is six inches wide and is attached to the board approximately one inch from the front edge of the underside of the board and curves reflexively to be essentially parallel to the top surface of the board. The riser 28 is eight inches in height near the front of the device and tapers to approximately seven inches in height near the rear of the device.

Measuring approximately nineteen inches in total length and approximately twelve inches in width at its widest point, the top of the Snow Body Board tapers toward its front. The Snow Body Board measures approximately one and one half inches in thickness at the rear of the board with the thickness decreasing gradually toward the front end of the board. The Snow Body Board is produced in a variety of dazzling colors and designs.

Use of the Snow Body Board is simple and straight forward. The Snow Body Board is utilized on a variety of hills and slopes. Sitting atop the present invention, the user positions their legs toward the front of the board, elevating them slightly. Leaning forward, the user grasps the Snow Body Board's integrated handles. Pushing off with their feet, the user lifts and places their feet on the board and proceeds down the slopes, using the handles and body position to steer the board.

The Snow Body Board provides novice snowboarding enthusiasts a safe and simple way in which to participate in the snowboarding sport. Ridden in a seated position, the Snow Body Board enables a beginning rider to enjoy the thrill of gliding down the slopes without requiring them to stand upright in order to do so. Sleek and aerodynamic, the Snow Body Board provides a spirited ride from a safer grounded level. Durably constructed, the Snow Body Board will withstand season after season of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A snowboard to be used by a rider in a seated position comprising:
an oval or egg shaped board having a top side and an underside, with the narrow portion at the front of the board;
further comprising a blade which is attached to the underside of the board lengthwise by means of a riser wherein the blade curves reflexively to be essentially parallel to the top surface of the board.

2. The snowboard of claim 1 further comprising openings on each side of the board which openings function as handles.

3. The snowboard of claim 2 wherein the openings are elongated semi-circular in shape.

4. The snowboard of claim 2 wherein the length of attachment of the riser is approximately sixteen inches.

5. The snowboard of claim 2 wherein the blade is six inches wide.

6. The snowboard of claim 2 wherein the blade is attached to the board approximately one inch from the edge of the front end of the underside of the board.

7. The snowboard of claim 2 comprised primarily of fiberglass or wooden material.

8. The snowboard of claim 2 wherein the entire length of the board is approximately nineteen inches.

9. The snowboard of claim 2 wherein the riser is approximately eight inches in height near the front of the board and tapers to approximately seven inches in height near the rear of the board.

10. The snowboard of claim 2 wherein the blade is approximately six inches wide.

11. The snowboard of claim 2 wherein the board is approximately twelve inches in width at its widest point.

12. The snowboard of claim 2 wherein the thickness of the board is approximately one and one half inches in thickness at the rear of the board and decreases gradually to one inch toward the front of the board.

13. The snowboard of claim 2 produced in a variety of dazzling colors and designs.

14. The snowboard of claim 2 wherein the handle openings are approximately seven inches long and two and one half inches wide.

15. The snowboard of claim 2 wherein the distance between handle openings is approximately three inches.
